(19) United States
(12) Patent Application Publication
(10) Pub. No.: US 2021/0239484 A1
(43) Pub. Date: Aug. 5, 2021

(54) Computer-Implemented Method and System for Determining a Deviation of an Estimated Value of an Average Traveling Time for Traveling Along a Section of Route from a Measured Value of a Traveling Time Taken for Traveling Along the Section of Route

(71) Applicant: Bayerische Motoren Werke Aktiengesellschaft, Muenchen (DE)

(72) Inventor: Stefan HOLDER, Muenchen (DE)

(21) Appl. No.: 17/167,508

(22) Filed: Feb. 4, 2021

(30) Foreign Application Priority Data
Feb. 5, 2020 (DE) 10 2020 102 883.0

(51) Int. Cl. G01C 21/34; G07C 5/08; G06F 16/29

(52) U.S. Cl. CPC G01C 21/3492; G06F 16/29; G07C 5/0841

(57) ABSTRACT

A system and computer-implemented method determines a deviation of an estimated value of an average traveling time of a vehicle for traveling along a section of a route with the vehicle from a measured value of a traveling time taken for traveling along the section of the route with the vehicle or another vehicle.

### CROSS REFERENCE TO RELATED APPLICATION

This application claims priority under 35 U.S.C. § 119 from German Patent Application No. DE 10 2020 102 883.0, filed Feb. 5, 2020, the entire disclosure of which is herein expressly incorporated by reference.

### BACKGROUND AND SUMMARY OF THE INVENTION

The disclosure concerns a computer-implemented method for determining a deviation of an estimated value of an average traveling time of a vehicle for traveling along a section of route with the vehicle from a measured value of a traveling time taken for traveling along the section of route with the vehicle or another vehicle. The invention further concerns a software program, which is designed to carry out the computer-implemented method when it is run on a computer. The disclosure also concerns a system for determining the deviation of the estimated value of the average traveling time from the measured value of the traveling time taken.

Hybrid or electric vehicles are driven by an electric motor, the necessary electrical energy being stored for example in a high-voltage storage unit. The high-voltage storage unit can be charged at a home charging station or a (public) charging station or a charging point. For such vehicles, energy requirement forecasts or range forecasts can be prepared in order to inform a driver, for example, as to whether a destination can be reached with the available energy reserves. For the energy requirement forecast or range forecast, in addition to acceleration maneuvers (turnoff, right-of-way sign, etc.), a mean speed, that is to say average speed, for each section of route is used to derive the energy requirement or the range from it.

Vehicles and cell phones have position and/or movement data from which traveling times for traveling along sections of route, also known as completion times or transit times, or average speeds for these sections of route can be calculated. There are the requirements to provide a forecast or prediction of the current average speed for sections of route with no or few completions or transits and to make a forecast of average speeds for predictive traffic, for example a predictive estimate of the average speed for a section of route in 30 minutes starting from the current time. It may also be required for the current traffic, known as “live traffic”, for which the current traffic situation is displayed in the navigation system, that a forecast or prediction of the current average speed for sections of route is performed with no or few completions or transits. By means of the estimated average speed and/or estimated transit time of a section of route, it is therefore possible to derive a time of arrival in the course of a navigation operation that is planned, in progress or completed for a route comprising at least one section of route and/or an energy requirement or a range for this route.

According to the prior art, both requirements are addressed by statistical models or machine learning algorithms that serve the purpose of calculating from the measured values of the traveling time taken for a journey through a given section of route the estimated value of the average traveling time for the journey through the given section of route. The average speed and average traveling time, that is to say average transit time, of a section of route can be converted into one another over the length of the section of route.

In order to indicate how well the estimate/forecast/prediction of an average speed or transit time for each section of route coincides with the so-called “ground truth”, a deviation function, also known as a cost function, is required. “Ground truth” means that a (true) value, measured by means of position and/or movement data, for a prediction is known, that is to say for example the actual transit time of a section of route in the form of a section of road, also known as a “link”, is measured with or in a vehicle. Usually, cost functions such as the mean squared error (MSE) function or the mean absolute percentage error (MAPE) function are used for the estimate/prediction of traveling times. On the basis of these ground truth data, models for determining the estimated traveling times from the measured traveling times for a respective section of route are therefore developed or learned. This requires the cost function, which measures how well the estimate/prediction coincides with the ground truth. These cost functions have the disadvantage, however, that they lead to an undesired distortion (bias), which has the effect that not all of the relevant errors between the estimated and measured traveling times for all sections of route are balanced out in the average.

A further application of the deviation function/cost function is the determination/measurement of the quality of data of RTTI (Real-Time Traffic Information) services, also known as service providers or just providers, and/or routing providers, with the ground truth transit times of vehicles from their collected and processed position and/or movement data, for example vehicles of the BMW fleet from Floating Car Data (FCD). This case likewise requires a deviation function/cost function, with which the deviations of the traveling times reported by the provider, that is to say at least partially estimated, from the actual traveling times are measured.

In principle, a relative deviation function/cost function with the possibility of indicating a relative error, for example percentage error, is to be preferred, since errors in the estimated transit time are often in proportion to the actually measured transit time as a percentage. Thus, a smaller error is to be expected for a short actual transit time (for example 5 minutes) than for a long transit time (for example 1 hour). The cost function of the mean squared errors, also known as the least squares, does not however measure the relative (percentage) error. A cost function known from the prior art for the relative error is the MAPE function. A disadvantage of the MAPE cost function is that it results in overoptimiztic traveling time estimates, that is to say traveling times that are estimated to be too short, as described in Tofallis, Chris. “A better measure of relative prediction accuracy for model selection and model estimation.”, Journal of the Operational Research Society 66.8 (2015), 1352-1362.

According to this prior art, the so-called SMAPE (symmetric mean absolute percentage error) function may also be used as a cost function. The SMAPE function delivers values that can be interpreted equally well and has a lower bias than the MAPE function, the bias being dependent on the distribution of the actual traveling times for the respective sections of route. However, there is no bias of zero for all of the distributions of actual traveling times, with which all of the relative errors between estimated and measured traveling times for all of the sections of route are balanced out in the average. In the case of log-normally (ln) distributed traveling times, which are described in Guessous, Younes, et al., “Estimating travel time distribution under different traffic conditions.”, Transportation Research Procedia 3 (2014, 339-348, the SMAPE function is minimized by the median of the actual traveling times. This has the disadvantage that estimated traveling times of neighboring sections of route cannot generally be added, since the median is not additive.

It is an object of the present invention to determine a deviation of an estimated value of an average traveling time for traveling along a section of route from a measured value of a traveling time taken for traveling along the section of route by means of a deviation function that avoids the disadvantages of the prior art. In particular, the deviation function is intended to be carried out in such a way that estimated traveling times of neighboring sections of route can be added. At least whenever the estimated value of the average traveling time is formed by means of a constant factor, the deviation function is also intended to achieve the effect that all of the relative errors are balanced out in the average, and consequently have no bias.

This object is achieved by the respective subject matter of the independent claims. Advantageous designs of the invention are specified in the subclaims.

In the case of the computer-implemented method according to the invention for determining a deviation of an estimated value of an average traveling time of a vehicle for traveling along a section of route with the vehicle from a measured value of a traveling time taken for traveling along the section of route with the vehicle or another vehicle, a deviation function is provided in such a way that the deviation function includes a quotient from the estimated value of the average traveling time of the vehicle and the measured value of the traveling time taken for traveling along the section of route with the vehicle or the other vehicle. The deviation function is also provided such that, if the arithmetic mean of the measured values of the traveling times taken for a number of journeys through the section of route is entered in the deviation function as the estimated value of the average traveling time, the deviation function is minimized in dependence on the estimated value of the average traveling time. Finally, the deviation function is additionally provided in such a way that, if the estimated value of the average traveling time is formed as the multiplication of a constant factor by a function value of a feature vector with at least one attribute that is suitable for an estimate of the average traveling time through the section of route, the deviation function is minimized in dependence on the constant factor if the arithmetic mean of the quotient from the estimated values of the average traveling times and the measured values of the traveling times taken respectively for a number of journeys through the section of route gives one. The deviation of the estimated value of the average traveling time for traveling along the section of route from the measured value of the traveling time taken for traveling along the section of route is determined on the basis of a function value of the deviation function for the estimated value of the average traveling time of the vehicle for traveling along the section of route with the vehicle.

The deviation function therefore includes the quotient from the estimated value of the average traveling time of the vehicle and the measured value of the traveling time taken for a journey through the section of route with the vehicle or the other vehicle, and therefore the relative error of the estimated value of the average traveling time in relation to the measured value of the traveling time taken for the respective section of route. Since the deviation function is minimized in dependence on the estimated value of the average traveling time if the arithmetic mean of the measured values of the traveling times taken for a number of journeys through the section of route is entered in the deviation function as the estimated value of the average traveling time, the estimated traveling times of neighboring sections of route can be added.

It is likewise advantageous that, if the estimated value of the average traveling time is formed as the multiplication of a constant factor by a function value of a feature vector with at least one attribute that is suitable for an estimate of the average traveling time through the section of route, the deviation function is minimized in dependence on the constant factor if the arithmetic mean of the quotient from the estimated values of the average traveling times and the measured values of the traveling times taken respectively for a number of journeys through the section of route gives one. This is so because in this case the deviation function according to the invention achieves the effect that all of the relative errors of the estimated value of the average traveling time in relation to the measured value of the traveling time taken for the respective sections of route are balanced out in the average, and there is no bias.

The requirements to provide a forecast or prediction of the current average speed for sections of route with no or few completions or transits and to make a forecast of average speeds for predictive traffic are therefore met better by the deviation function according to the invention than by the deviation functions according to the prior art.

In one embodiment of the invention, for delivering a service of providing real-time traffic information, for example RTTI services, first position and/or movement data, for example Floating Car Data (FCD), are collected from vehicles for one or more sections of route of a route that is to be traveled or has been traveled. Then a model is learned, intended to estimate/forecast/predict the average speed traveled in dependence on the road link, that is to say the section of route, time of day, day of the week and type of road, that is to say one-way street, town or country road, federal highway or freeway. A neural network is suitable for example as a learning algorithm, since it can be trained in an easy way with a self-defined deviation function/cost function. The deviation function according to the invention is used as the deviation function. The model is used to estimate/forecast traveling times/average speeds, and can consequently be used for current traffic with real-time traffic information, for example live RTTI traffic, or for predictive traffic with real-time traffic information, for example predictive RTTI traffic, and also time-dependent routing.

Advantageously, the deviation function is provided in such a way that it gives zero if the estimated values of the average traveling times coincide with the measured values of the traveling times taken for all of the journeys through the section of route.

If the deviation function includes the estimated value of the average traveling time and the measured value of the traveling time taken exclusively in the form of the quotient from the estimated value of the average traveling time and the measured value of the traveling time taken, a deviation function that includes exclusively the relative error of the estimated value of the average traveling time in relation to the measured value of the traveling time taken is advantageously obtained. This simplifies the handling and interpretation of the input data comprising estimated values of the average traveling time and measured values of the traveling time taken and the function values of the deviation function as output data.

In an advantageous embodiment of the invention, the deviation function includes the quotient from the estimated value of the average traveling time and the measured value of the traveling time taken as the quotient of the estimated value of the average traveling time divided by the measured value of the traveling time taken, in order to obtain the relative error of the estimated value of the average traveling time in relation to the measured value of the traveling time taken.

In a preferred embodiment, the deviation function is minimized in dependence on the constant factor if the arithmetic mean of the quotient from the estimated value of the average traveling time and the measured value of the traveling time taken, as the arithmetic mean of the quotient of the estimated values of the average traveling time divided by the measured values of the traveling times taken respectively for a number of journeys through the section of route, gives one. The quotient of the estimated values of the average traveling time divided by the measured values of the traveling times taken respectively for a number of journeys through the section of route gives the relative error of the estimated value of the average traveling time in relation to the measured value of the traveling time taken.

In a particularly preferred embodiment, the deviation function f(xᵢ, yᵢ) is provided in the form:

$$f ( {x}_{i} , {y}_{i} ) = \frac{1}{n} {\sum }_{i = 1}^{n} \frac{{y}_{i}}{{x}_{i}} - ln \frac{{y}_{i}}{{x}_{i}} - 1$$

with the estimated value xᵢ of the average traveling time and the measured value yᵢ of the traveling time taken for a journey i in the case of a number of n journeys through the section of route. The deviation function therefore takes the form of a simple and short function, the estimated value xᵢ of the average traveling time and the measured value yᵢ of the traveling time taken being included exclusively in the form of the quotient from the estimated value xᵢ of the average traveling time and the measured value yᵢ of the traveling time taken, that is to say as a relative error between the estimated value xᵢ of the average traveling time and the measured value yᵢ of the traveling time taken for the journey i. By the subtraction of 1 at the end of the function, it is ensured that the deviation function gives zero if the estimated values xᵢ of the average traveling times coincide with the measured values yᵢ of the traveling times taken for all of the journeys through the section of route.

If the first derivative of the deviation function f(x, yᵢ) on the basis of the estimated value x of the average traveling time for a number of measured values yᵢ of the traveling times taken is set to zero, this gives:

$$\frac{1}{n} {\sum }_{i = 1}^{n} \frac{{y}_{i}}{x} - ln \frac{{y}_{i}}{x} - 1 dx = \frac{1}{n} {\sum }_{i = 1}^{n} - \frac{{y}_{i}}{{x}^{2}} + \frac{{y}_{i}}{{x}^{2}} * \frac{x}{{y}_{i}} = \frac{1}{n} {\sum }_{i = 1}^{n} - \frac{{y}_{i}}{{x}^{2}} + \frac{1}{x} = 0 \vert * n \\ {\sum }_{i = 1}^{n} \frac{1}{x} = {\sum }_{i = 1}^{n} \frac{{y}_{i}}{{x}^{2}} \vert * {x}^{2}$$

$$nx = {\sum }_{i = 1}^{n} {y}_{i}$$

$$x = \frac{1}{n} {\sum }_{i = 1}^{n} {y}_{i}$$

The second derivative of the deviation function f(x, yᵢ) on the basis of the estimated value x of the average traveling time

$$\frac{1}{n} {\sum }_{i = 1}^{n} \frac{{y}_{i}}{x} - ln \frac{{y}_{i}}{x} - 1 dx dx$$

$$\frac{1}{n} {\sum }_{i = 1}^{n} - \frac{{y}_{i}}{{x}^{2}} + \frac{1}{x} d x = \frac{1}{n} {\sum }_{i = 1}^{n} 2 \frac{{y}_{i}}{{x}^{3}} - \frac{1}{{x}^{2}} = \frac{1}{n {x}^{2}} {\sum }_{i = 1}^{n} 2 \frac{{y}_{i}}{x} - 1 = \frac{1}{n {x}^{2}} * ( \frac{2}{x} ( {\sum }_{i = 1}^{n} {y}_{i} ) - n )$$

$$when using$$

$$x = \frac{1}{n} {\sum }_{i = 1}^{n} {y}_{i} \frac{1}{{n ( \frac{1}{n} {\sum }_{i = 1}^{n} {y}_{i} )}^{2}} * ( 2 \frac{{\sum }_{i = 1}^{n} {y}_{i}}{\frac{1}{n} {\sum }_{i = 1}^{n} {y}_{i}} - n ) = \frac{1}{{( \frac{1}{n} {\sum }_{i = 1}^{n} {y}_{i} )}^{2}} > 0$$

gives a minimum in such a way that the deviation function f(x, yᵢ) in dependence on the estimated value x of the average traveling time is minimized if the arithmetic mean

$$x = \frac{1}{n} {\sum }_{i = 1}^{n} {y}_{i}$$

of the traveling times taken for a number of journeys i of 1 to n through the section of route is entered into the deviation function f(x, yi) as the estimated value x of the average traveling time.

If in the deviation function f(xi, yᵢ) the estimated value xᵢ of the average traveling time is formed as the multiplication of a constant factor a by a function value f(sᵢ) of a feature vector sᵢ for the journey i in the case of a number of n journeys with at least one attribute that is suitable for an estimate of the average traveling time through the section of route, that is to say

xᵢ=a*f(sᵢ),

the first derivative of the deviation function f(xi, yᵢ) is obtained in dependence on the constant factor a

$$\frac{1}{n} {\sum }_{i = 1}^{n} \frac{{y}_{i}}{a f ( {s}_{i} )} - ln \frac{{y}_{i}}{a f ( {s}_{i} )} - 1 da = \frac{1}{n} {\sum }_{i = 1}^{n} - \frac{{y}_{i}}{{a}^{2} f ( {s}_{i} )} + \frac{1}{a} = 0 \vert * an \\ {\sum }_{i = 1}^{n} - \frac{{y}_{i}}{a f ( {s}_{i} )} + 1 = 0 \\ a = \frac{1}{n} {\sum }_{i = 1}^{n} \frac{{y}_{i}}{f ( {s}_{i} )} \\ n = {\sum }_{i = 1}^{n} \frac{{y}_{i}}{{x}_{i}} \vert / n \\ \frac{1}{n} {\sum }_{i = 1}^{n} \frac{{y}_{i}}{{x}_{i}} = 1$$

By analogy with the second derivative presented above of the deviation function f(xi, yᵢ) on the basis of the estimated value x of the average traveling time, the second derivative of the deviation function f(xi, yᵢ) in dependence on the constant factor a

$$\frac{1}{n {a}^{2}} * ( \frac{2}{a} ( {\sum }_{i = 1}^{n} \frac{{y}_{i}}{f ( {s}_{i} )} ) - n )$$

$$when using a = \frac{1}{n} {\sum }_{i = 1}^{n} \frac{{y}_{i}}{f ( {s}_{i} )} \frac{1}{{( \frac{1}{n} {\sum }_{i = 1}^{n} \frac{{y}_{i}}{f ( {s}_{i} )} )}^{2}} > 0$$

gives a minimum if the arithmetic mean of the quotient from the estimated values xᵢ of the average traveling times and the measured values yᵢ of the traveling times taken respectively for a number of journeys i of 1 to n through the section of route gives one:

$$\frac{1}{n} {\sum }_{i = 1}^{n} \frac{{y}_{i}}{{x}_{i}} = 1$$

This means that the deviation function achieves that all of the relative errors of the estimated values xᵢ of the average traveling times in relation to the measured values yᵢ of the traveling times taken are balanced out in the average, and there is no bias.

The feature vector sᵢ contains one or more attributes that are suitable for an estimate/prediction of the average traveling time for a section of route:
traveling time of a vehicle for this section of route,
time of day,
day of the week,
map attribute such as type of road (functional class), category of road (town, country road, freeway), speed limit, no passing.

If there are a number of transits of the same section of route at one time of day/on one day of the week, the deviation function is minimized by the arithmetic mean of the measured values yᵢ of the traveling times taken for the individual journeys. If there are sections of route without transits, a calculation/averaging/interpolation of the transits is performed by a model, which serves the purpose of calculating from the measured values yᵢ of the traveling time taken for a journey i through a given section of route the estimated value xᵢ of the average traveling time for the journey through the given section of route on the basis of the remaining attributes, for example by a machine learning method.

The function a*f(sᵢ) for xᵢ, also known as g(sᵢ), may for example be formed as a linear regression or as a neural network. Another embodiment of the function a*f(sᵢ) for xᵢ is that it is attempted to improve a given estimate/prediction model by multiplying all of the estimates/predictions by the factor a, in order in this way to minimize the deviation function further. This could happen for example at a service provider, in order to minimize the cost function prescribed by the service recipient. In this case, it is advantageous that all of the relative errors of the estimated value xᵢ of the average traveling time in relation to the measured value yᵢ of the traveling time taken are balanced out, i.e. the optimization carried out by the provider leads to the desired result.

In an advantageous embodiment, over a length of the section of route, the estimated value of the average traveling time is converted into an estimated value of the average speed and/or the measured value of the traveling time taken is converted into a measured value of the average speed traveled, in order to determine a deviation of the estimated value of the average speed for traveling along the section of route from the measured value of the average speed traveled for traveling along the section of route. In this way, the method according to the invention can be used in all of the embodiments as an alternative or in addition to a traveling time for an average speed.

The invention also comprises a software program, which is designed to carry out the computer-implemented method according to one of the preceding embodiments when it is run on a computer, the computer preferably being a distributed computer system, of which preferably part is arranged in a cloud computer system. The software program may be designed to be run on one or more processors, and in this way carry out the method according to the invention. The software program may be stored on one or more storage media.

The invention also comprises a system for determining a deviation of an estimated value of an average traveling time of a vehicle for traveling along a section of route with the vehicle from a measured value of a traveling time taken for traveling along the section of route with the vehicle or another vehicle. It comprises a functional unit, which is designed for providing a deviation function in such a way that the deviation function includes a quotient from the estimated value of the average traveling time of the vehicle and the measured value of the traveling time taken for a journey through the section of route with the vehicle or another vehicle. The functional unit is also designed for providing a deviation function in such a way that the deviation function is minimized in dependence on the estimated value of the average traveling time if the arithmetic mean of the measured values of the traveling times taken for a number of journeys through the section of route is entered in the deviation function as the estimated value of the average traveling time. In addition, the functional unit is designed for providing the deviation function in such a way that, if the estimated value of the average traveling time is formed as the multiplication of a constant factor by a function value of a feature vector with at least one attribute that is suitable for an estimate of the average traveling time through the section of route, the deviation function is minimized in dependence on the constant factor if the arithmetic mean of the quotient from the estimated values of the average traveling times and the measured values of the traveling times taken respectively for a number of journeys through the section of route gives one. The system also comprises an assessment unit, which is designed for determining the deviation of the estimated value of the average traveling time for traveling along the section of route from the measured value of the traveling time taken for traveling along the section of route on the basis of a function value of the deviation function for the estimated value of the average traveling time of the vehicle for traveling along the section of route with the vehicle.

The system according to the invention has advantages and effects corresponding to the method according to the invention. The functional unit and assessment unit may take the form of separate units or an integrated unit, for example in a backend server.

The functional unit and the assessment unit may therefore be combined in a backend server and/or be comprised by an electronic control unit (ECU) of the vehicle.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a schematic representation of a section of route that is traveled by a vehicle, according to the prior art.

FIG. 2 is a diagram for a determination of a deviation of an estimated value of an average traveling time for traveling along a section of route from a measured value of a traveling time taken for traveling along the section of route, according to a first embodiment of the invention.

FIG. 3 is a graphic comparison of the profiles of two deviation functions for the same range of estimated values of an average traveling time for traveling along a section of route, a minimum of a deviation function according to a second embodiment of the invention indicating a higher estimated value of the average traveling time than a minimum of a deviation function according to the prior art.

FIG. 4 is a diagram of the system according to a further embodiment of the invention for providing a vehicle with estimated values of an average traveling time for traveling along a section of route.

Unless indicated otherwise, the same designations are used below for elements that are the same or have the same effect.

### DETAILED DESCRIPTION OF THE DRAWINGS

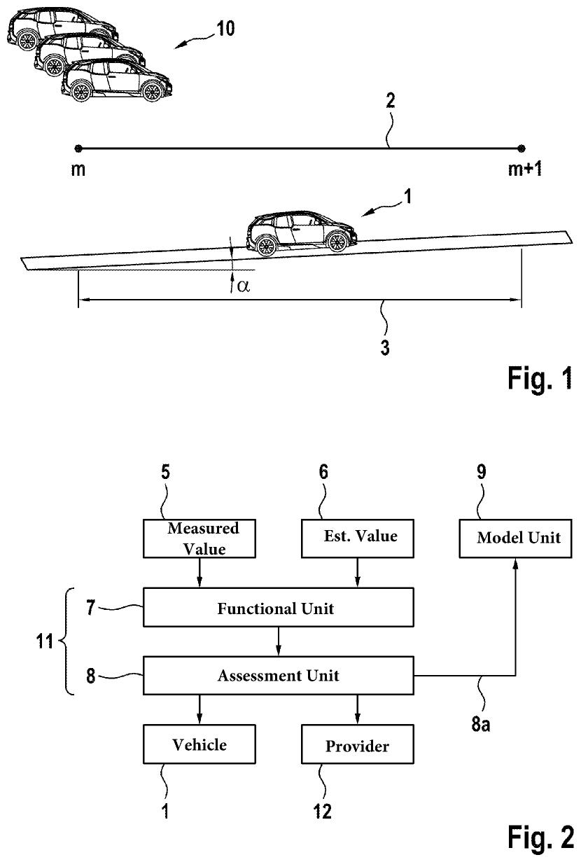

FIG. 1 shows a schematic representation of a section of route 2, which is to be traveled along by a vehicle 1, for which an energy requirement forecast is prepared. The section of route 2 to be traveled along by the vehicle 1 has a length 3. The entire route to be traveled along by the vehicle 1 can merely consist of the section of route 2. It is however also possible that, before the section of route 2, m−1 previous sections of route have already been traveled along, where m is a positive whole number. According to this nomenclature, the section of route 2 represents the section of route m, which may be adjoined by the further section of route m+1. For the energy requirement forecast or range forecast, in addition to acceleration maneuvers (turnoff, right-of-way sign, etc.), a mean speed, that is to say average speed, for the section of route 2 is used to derive the energy requirement or the range from it. Over the length 3, the average speed at which the section of route 2 is traveled along can be converted into a traveling time for traveling along the section of route 2. With the traveling time for traveling along the section of route 2, and possibly the previous sections of route 1 to m−1 and/or the subsequent sections of route m+1 to z, where z is a positive whole number greater than m, the time of arrival for the vehicle 1 can be calculated/determined within the vehicle 1 and/or outside the vehicle 1, for example in a backend server.

Position and/or movement data for the calculation/determination of a measured value of a traveling time taken for traveling along the section of route 2 can be provided/collected from an earlier journey of the vehicle 1 or from a vehicle. For example, the position and/or movement data of fleet vehicles 10 may be provided. Fleet vehicles 10 may be vehicles of the same or a similar type of vehicle. In particular, the fleet may contain a multiplicity of vehicles 10 of the same type as and/or a similar type to the vehicle 1 for which the energy requirement for the section of route 2 is being calculated (“ego vehicle”). The fleet may in particular comprise a multiplicity of other vehicles 10 and optionally the ego vehicle 1.

FIG. 2 shows a diagram for a determination of a deviation of an estimated value 6 of an average traveling time for traveling along at least the section of route 2 from a measured value 5 of a traveling time taken for traveling along the section of route 2 according to a first embodiment of the invention. The requirements to provide a forecast or prediction of the current average speed for the section of route 2 with no or few completions or transits and to make a forecast of the average speed for predictive traffic, concerning the section of route 2, are met by statistical models or machine learning algorithms that serve the purpose of calculating from the measured values 5 of the traveling time taken for a journey through the section of route 2 the estimated value 6 of the average traveling time for the journey through the given section of route 2. In order to indicate how well the estimate/forecast/prediction of the traveling time (or average speed) for the section of route 2 coincides with the collected measured values 5 of the traveling time taken, a deviation function according to the present invention is used.

For determining a deviation of the estimated value 6 of the average traveling time of the vehicle 1 for traveling along the section of route 2 with the vehicle 1 from the measured value 5 of the traveling time taken for traveling along the section of route 2 with the vehicle 1 or another vehicle, for example the fleet vehicle 10, the estimated value 6 of the average traveling time of the vehicle 1 for traveling along the section of route 2 and the measured value 5 of the traveling time taken for traveling along the section of route 2 are fed to a functional unit 7. The functional unit 7 is designed for providing the deviation function in such a way that the deviation function includes a quotient from the estimated value 6 of the average traveling time of the vehicle 1 and the measured value 5 of the traveling time taken for a journey through the section of route 2 with the vehicle 1 or the other vehicle. The functional unit 7 is also designed for providing the deviation function in such a way that the deviation function is minimized in dependence on the estimated value 6 of the average traveling time if the arithmetic mean of the measured values 5 of the traveling times taken for a number of journeys through the section of route 2 is entered in the deviation function as the estimated value 6 of the average traveling time and that, if the estimated value 6 of the average traveling time is formed as the multiplication of a constant factor by a function value of a feature vector with at least one attribute that is suitable for an estimate of the average traveling time through the section of route 2, the deviation function is minimized in dependence on the constant factor if the arithmetic mean of the quotient from the estimated values 6 of the average traveling times and the measured values 5 of the traveling times taken respectively for a number of journeys through the section of route 2 gives one.

The functional unit 7 is connected to an assessment unit 8, which is designed for determining the deviation of the estimated value 6 of the average traveling time for traveling along the section of route 2 from the measured value 5 of the traveling time taken for traveling along the section of route 2 on the basis of a function value of the deviation function for the estimated value 6 of the average traveling time of the vehicle 1 for traveling along the section of route 2 with the vehicle 1. The assessment unit 8 may be connected to a model unit 9, which is designed for providing and executing a model for an estimate/forecast/prediction of the traveling time for traveling along the section of route 2, by means of a connection 8a, as is represented in FIG. 2. By feeding to the model unit 9 function values of the deviation function that indicate how well the estimate/prediction of the average traveling time coincides with the traveling time taken, the model comprised by the model unit 9 for determining the estimated traveling times from the measured traveling times for the respective section of route 2 can be developed, learned and/or optimized. The model for determining the estimated traveling times from the measured traveling times may comprise statistical methods, machine learning algorithms and/or a neural network.

The functional unit 7 and the assessment unit 8 may be combined into and integrated within a deviation determining unit 11, which may be arranged in a backend server. In addition to being transferred to the model unit 9, according to FIG. 2 the deviation of the estimated value 6 of the average traveling time for traveling along the section of route 2 from the measured value 5 of the traveling time taken for traveling along the section of route 2 on the basis of a function value of the deviation function for the estimated value of the average traveling time of the vehicle 1 for traveling along the section of route 2 with the vehicle 1 can be transferred to the vehicle 1 and/or to a provider 12. For example, the quality of estimated data 6 of the provider 12 with respect to real-time traffic information and/or routing can be established with the measured data 5 for example of the vehicle 1 or of the fleet vehicle 10. The provider 12 can optimize its estimated data 6, that is to say bring them closer to the measured data, by choosing the estimated values 6 such that the deviation function is minimized, that is to say indicates the smallest deviation of the estimated value 6 from the measured value. It is of significance in this connection that a minimization of the deviation function leads to a greatest possible coincidence of the estimated value 6 with the measured values 5, that is to say to the “best” estimated traveling times.

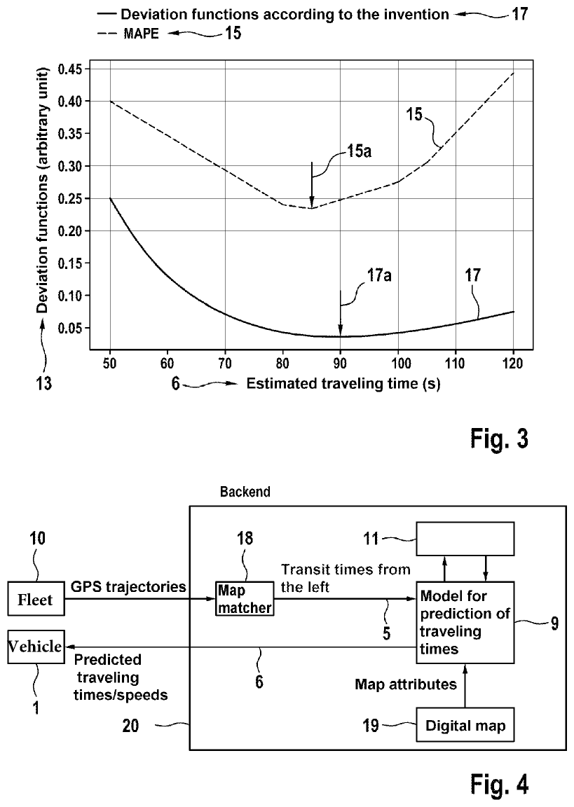

FIG. 3 shows a graphic comparison of the profiles of two deviation functions 15, 17 for the same range of estimated values 6 of an average traveling time for traveling for example along the section of route 2. The deviation of the estimated value 6 of the average traveling time for traveling for example along the section of route 2 from the measured value 5 of the traveling time taken for traveling along the section of route 2 is obtained in an arbitrary unit from the function values 13 of the two deviation functions 15, 17 for a respective estimated value of the average traveling time of the vehicle 1 for traveling along the section of route 2 with the vehicle 1.

A minimum 17a of the deviation function 17 according to the invention in the form of the function f(xᵢ, yᵢ) already presented above

$$f ( {x}_{i} , {y}_{i} ) = \frac{1}{n} {\sum }_{i = 1}^{n} \frac{{y}_{i}}{{x}_{i}} - ln \frac{{y}_{i}}{{x}_{i}} - 1$$

with the estimated value xᵢ of the average traveling time and the measured value yᵢ of the traveling time taken for a journey i in the case of a number of n journeys through the section of route is obtained for the estimated value 6 as 90 seconds. This estimated value of the average traveling time of 90 seconds is higher than a minimum 15a of the MAPE deviation function according to the prior art, which lies at 85 seconds. The following measured values 5 for traveling times were measured in the past for the section of route 2: 50 seconds, 80 seconds, 85 seconds, 100 seconds, 105 seconds and 120 seconds. As represented in FIG. 3, only the deviation function 17 according to the invention gives the minimum 17a for the estimated value of the average traveling time of 90 seconds as the arithmetic mean of the measured values 5 of the traveling times taken. If, on the other hand, the MAPE function is used as the deviation function 17, an overoptimistic estimate is achieved as the minimum 15a in the form of the too-low estimated value of 85 seconds.

FIG. 4 shows a diagram of the system according to a further embodiment of the invention for providing the vehicle 1 with estimated values 6 of an average traveling time for traveling along at least the section of route 2.

With the aid of a map matching unit 18, also known as a map matcher unit, measured values 5 of traveling times taken for traveling along sections of route 2 or transit times for these sections of route 2 can be calculated from position data in the form of GPS trajectories (GPS: Global Positioning System) including timestamps of the fleet vehicles 10. The map matching unit 18 may be arranged in a backend server 20. Alternatively, the map matching unit 18 for matching a map to the position data, also known as “map matching”, and for calculating the measured values 5 of the traveling times taken for traveling along the sections of route 2 may already be provided in the vehicle 1.

The estimated/predicted values 6 for the average traveling times that are calculated in the model unit 9 for an estimate/prediction of traveling times from the measured values 5 of traveling times taken, with the aid of a map unit 19 that contains map material for example in a digital form, can then be made available to the vehicle 1, which is possibly not one of the fleet vehicles 10, as real-time traffic information, for example as live/predictive RTTI data, and/or in the form of a routing service for example. By exchanging the estimated values 6 of average traveling times for traveling along the section of route 2 and the measured values 5 of traveling times taken for traveling along the section of route 2 between the model unit 9 and the deviation determining unit 11, which comprises the functional unit 7 and the assessment unit 8, an optimization of the model of the model unit 9 for estimating the average traveling times can take place in such a way that deviations of the estimated values 6 of average traveling times from the measured values 5 of the traveling times taken are minimized.

Unless indicated to the contrary or ruled out for technical reasons, the features of the invention described with reference to the embodiments shown, for example the use of the deviation function 17 represented in FIG. 3, can also be present in other embodiments of the invention, for example in the functional unit 7 represented in FIG. 2 or the deviation determining unit 11 represented in FIG. 4.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A computer-implemented method for determining a deviation of an estimated value of an average traveling time of a vehicle for traveling along a section of a route with the vehicle from a measured value of a traveling time taken for traveling along the section of the route with the vehicle or another vehicle, the method comprising the steps of:
providing a deviation function such that the deviation function includes a quotient from the estimated value of the average traveling time of the vehicle and the measured value of the traveling time taken for a journey through the section of the route with the vehicle or the other vehicle, wherein
the deviation function is minimized in dependence on the estimated value of the average traveling time if the arithmetic mean of measured values of traveling times taken for a number of journeys through the section of the route is entered in the deviation function as the estimated value of the average traveling time, and
if the estimated value of the average traveling time is formed as the multiplication of a constant factor by a function value of a feature vector with at least one attribute that is suitable for an estimate of the average traveling time through the section of the route, the deviation function is minimized in dependence on the constant factor if the arithmetic mean of the quotient from the estimated values of the average traveling times and the measured values of the traveling times taken respectively for a number of journeys through the section of the route gives one; and
determining the deviation of the estimated value of the average traveling time for traveling along the section of the route from the measured value of the traveling time taken for traveling along the section of the route on the basis of a function value of the deviation function for the estimated value of the average traveling time of the vehicle for traveling along the section of the route with the vehicle.

2. The computer-implemented method according to claim 1, wherein
the deviation function is provided so as to give zero if the estimated values of the average traveling times coincide with the measured values of the traveling times taken for all of the journeys through the section of the route.

3. The computer implemented method according to claim 1, wherein
the deviation function includes the estimated value of the average traveling time and the measured value of the traveling time taken exclusively in the form of the quotient from the estimated value of the average traveling time and the measured value of the traveling time taken.

4. The computer-implemented method according to claim 1, wherein
the deviation function includes the quotient from the estimated value of the average traveling time and the measured value of the traveling time taken as the quotient of the estimated value of the average traveling time divided by the measured value of the traveling time taken.

5. The computer-implemented method according to claim 1, wherein
the deviation function is minimized in dependence on the constant factor if the arithmetic mean of the quotient from the estimated value of the average traveling time and the measured value of the traveling time taken, as the arithmetic mean of the quotient of the estimated values of the average traveling time divided by the measured values of the traveling times taken respectively for a number of journeys through the section of the route, gives one.

6. The computer-implemented method according to claim 1, wherein
the deviation function f(xᵢ, yᵢ) is provided in the form
$$f ( {x}_{i} , {y}_{i} ) = \frac{1}{n} {\sum }_{i = 1}^{n} \frac{{y}_{i}}{{x}_{i}} - ln \frac{{y}_{i}}{{x}_{i}} - 1$$
with the estimated value xᵢ of the average traveling time and the measured value yᵢ of the traveling time taken for a journey i in the case of a number of n journeys through the section of the route.

7. The computer-implemented method according to claim 1, wherein
over a length of the section of the route, the estimated value of the average traveling time is converted into an estimated value of the average speed and/or the measured value of the traveling time taken is converted into a measured value of the average speed traveled, in order to determine a deviation of the estimated value of the average speed for traveling along the section of the route from the measured value of the average speed traveled for traveling along the section of the route.

8. A computer product comprising a non-transitory computer readable medium having stored thereon program code that, when executed, carries out the acts of:
providing a deviation function such that the deviation function includes a quotient from the estimated value of the average traveling time of the vehicle and the measured value of the traveling time taken for a journey through the section of the route with the vehicle or the other vehicle, wherein
the deviation function is minimized in dependence on the estimated value of the average traveling time if the arithmetic mean of measured values of traveling times taken for a number of journeys through the section of the route is entered in the deviation function as the estimated value of the average traveling time, and
if the estimated value of the average traveling time is formed as the multiplication of a constant factor by a function value of a feature vector with at least one attribute that is suitable for an estimate of the average traveling time through the section of the route, the deviation function is minimized in dependence on the constant factor if the arithmetic mean of the quotient from the estimated values of the average traveling times and the measured values of the traveling times taken respectively for a number of journeys through the section of the route gives one; and
determining the deviation of the estimated value of the average traveling time for traveling along the section of the route from the measured value of the traveling time taken for traveling along the section of the route on the basis of a function value of the deviation function for the estimated value of the average traveling time of the vehicle for traveling along the section of the route with the vehicle.

9. A system for determining a deviation of an estimated value of an average traveling time of a vehicle for traveling along a section of a route with the vehicle from a measured value of a traveling time taken for traveling along the section of the route with the vehicle or another vehicle, comprising:
a functional unit, which is configured for providing a deviation function such that the deviation function includes a quotient from the estimated value of the average traveling time of the vehicle and the measured value of the traveling time taken for a journey through the section of the route with the vehicle or the other vehicle, wherein
the deviation function is minimized in dependence on the estimated value of the average traveling time if the arithmetic mean of the measured values of the traveling times taken for a number of journeys through the section of the route is entered in the deviation function as the estimated value of the average traveling time, and
if the estimated value of the average traveling time is formed as the multiplication of a constant factor by a function value of a feature vector with at least one attribute that is suitable for an estimate of the average traveling time through the section of the route, the deviation function is minimized in dependence on the constant factor if the arithmetic mean of the quotient from estimated values of average traveling times and the measured values of the traveling times taken respectively for a number of journeys through the section of the route gives one; and
an assessment unit, which is configured for determining the deviation of the estimated value of the average traveling time for traveling along the section of the route from the measured value of the traveling time taken for traveling along the section of the route on the basis of a function value of the deviation function for the estimated value of the average traveling time of the vehicle (1) for traveling along the section of the route with the vehicle.

10. The system according to claim 9, wherein
the functional unit and the assessment unit are combined in a backend server.

11. The system according to claim 9, wherein
the functional unit and the assessment unit are embodied by an electronic control unit of the vehicle.
